(19) United States
(12) Patent Application Publication
(10) Pub. No.: US 2008/0211999 A1
(43) Pub. Date: Sep. 4, 2008

(54) Transflective Liquid Crystal Display Device

(75) Inventors: Samuel Gu, Surrey (GB); Charles Richard Manuel Schmidgall, Surrey (GB); Nicolas Bergeron, Surrey (GB); Harrie Hermens, Surrey (GB); Wk Mok, Surrey (GB); Xy Gong, Surrey (GB)

Correspondence Address: BIRCH STEWART KOLASCH & BIRCH, PO BOX 747, FALLS CHURCH, VA, 22040-0747, US

(73) Assignee: TPO Hong Kong Holding Limited, Hong Kong (CN)

(21) Appl. No.: 11/663,067

(22) PCT Filed: Sep. 15, 2005
(86) PCT No.: PCT/IB2005/053025

§ 371 Date: Jan. 15, 2008

(30) Foreign Application Priority Data
Sep. 17, 2004 (CN) PCTCN0401057

(51) Int. Cl. G02F 1/1335

(52) U.S. Cl. 349/106; 349/114

(57) ABSTRACT

A transflective display device has a color filter portion for each pixel which includes portions of two different thicknesses. In one implementation, both thicknesses are used for the reflective part of the pixel, and the relative thicknesses as well as the proportion of different thickness layers can be controlled to enable independent control of the color filtering characteristics in the reflective and transmissive modes of operation. Another implementation uses different portions of light absorbing material for the functions of pixel definition and height adjustment, but these may be achieved with a single patterned layer.

The present invention relates to a liquid crystal display, and more particularly, to a transflective liquid crystal display and method of fabricating the same.

Liquid Crystal Display (LCD) devices are relatively thin and require low power for operation, when compared to CRT display devices. LCD devices are gradually replacing CRT display devices in a variety of technical fields.

Until recently, there have been two basic types of liquid crystal display; transmissive displays and reflective displays, the main difference being whether an internal or external light source is used.

A transmissive display has a liquid crystal display panel that does not itself emit light, and has a backlight as a light source. The backlight is disposed at the rear or one side of the panel, and a light guide directs the light across the display area. The liquid crystal panel controls the amount of the light which passes through the liquid crystal panel, in order to implement an image display. The backlight of transmissive LCD displays typically consumes 50% or more of the total power consumption.

In order to reduce power consumption, reflective LCDs have been developed, primarily for portable applications. A reflective LCD is provided with a reflector formed on one of a pair of substrates. Thus, ambient light is reflected from the surface of the reflector. The performance of a reflective LCD is poor when there are low levels of ambient light.

To overcome the problems described above, so-called transflective displays have been developed, which combine a transmissive mode and a reflective mode in a single liquid crystal display device. A transflective liquid crystal display (LCD) device alternatively acts as a transmissive LCD device and a reflective LCD device. By using both internal and external light sources depending on the ambient conditions, it can be operated in all light conditions and has a low power consumption.

One problem encountered in colour transflective displays is that the same colour filters are used in the transmissive and reflective modes of operation. These colour filters cannot therefore be optmised for both functions. For example, in the reflective mode, light passes through the colour filter twice, in an incident direction and then in an exit direction, whereas light passes through the colour filter only once in the transmissive mode.

US 2003/0197192 discloses an arrangement in which part of the reflective pixel area is provided with no colour filter layer, so that white light mixes with the colour filtered light, thereby adjusting the colour point.

It has also been proposed to provide different colour filter layer thicknesses associated with different parts of the pixel. For example, US2003/0030055A1 discloses an arrangement in which the reflector Is provided on top of a black mask layer, and the colour filter layer is provided over the top. By raising the reflector in this way, the thickness of the colour filter layer is reduced for the reflective part of the pixel. US 2004/012529 also discloses an arrangement with a different thickness of colour filter layer for the transmissive and reflective parts of the pixel.

There is a need to provide further control of the different optical properties of the colour filter layer in the different modes of operation. There is also a need to enable this to be achieved with a low cost manufacturing process.

According to a first aspect of the invention, there is provided a transflective display device, comprising:

a first substrate carrying a plurality of pixel electrodes;

a second substrate comprising a plurality of counter-electrodes, an array of colour filter devices and a reflector arrangement, the reflector arrangement defining a reflective pixel region and a transmissive pixel region; and

a layer of display material sandwiched between the first and second substrates,

wherein the second substrate comprises a pattern of absorbing material portions provided at least at the boundaries between adjacent pixels and each pixel comprising a first region having a portion of the absorbing material and a second region not having any portion of the absorbing material, the reflector arrangement being provided on top of the absorbing material portions of the first region of the pixel, over the edge of the absorbing material portions and extending partly into the second pixel region, and wherein each pixel is provided with a colour filter having a first thickness in the first region of the pixel and a second, greater thickness in the second region of the pixel.

This arrangement provides a colour filter portion for each pixel which includes portions of two different thicknesses for the reflective part of the pixel, and the relative thicknesses as well as the proportion of the reflective pixel area associated with each different thickness can be controlled. This enables improved independent control of the colour filtering characteristics in the reflective and transmissive modes of operation.

The absorbing material portions are preferably provided at the boundaries between adjacent pixels, such that the central part of each pixel is the second region. These portions then perform the dual functions of defining the pixel boundaries as well as providing a height difference to enable multiple thickness filters to be formed.

The reflector arrangement preferably includes openings at the boundaries between pixels, so that the openings reveal the absorbing material to define the pixel boundaries.

According to a second aspect of the invention, there is provided a transflective display device, comprising:

a first substrate carrying a plurality of pixel electrodes;

a second substrate comprising a plurality of counter-electrodes, an array of colour filter devices and a reflector arrangement, the reflector arrangement defining a reflective pixel region and a transmissive pixel region; and

a layer of display material sandwiched between the first and second substrates,

wherein the second substrate comprises a first pattern of absorbing material portions at the boundaries between adjacent pixels and a second pattern of absorbing material portions in a central region of each pixel, the second pattern defining a first pixel region having a portion of the absorbing material and a second region not having any portion of the absorbing material, the reflector arrangement being provided on top of the absorbing material portions of the second pattern, and wherein each pixel is provided with a colour filter having a first thickness in the first region of the pixel and a second, greater thickness in the second region of the pixel.

In this arrangement, different portions of absorbing material are defined for the different functions of pixel definition and height adjustment, but these may be achieved with a single patterned layer.

The reflector arrangement can again be provided over the edge of the absorbing material portions of the second pattern and extend partly into the second pixel regions.

In either aspect, the reflective arrangement preferably comprises a patterned aluminium layer.

A backlight can be provided adjacent the second substrate for the transmissive mode of operation.

The colour filter devices can be formed from printed material, in multiple colours, and from a single printed layer.

The invention can be applied to passive or active matrix devices.

The invention also provides a method of manufacturing a colour filter substrate for a transflective display device in which a first substrate carries a plurality of pixel electrodes and a display material layer is provided between the first substrate and the colour filter substrate, the method comprising:

defining a pattern of absorbing material portions over a transparent substrate, the portions being provided at least at the boundaries between adjacent pixels thereby providing each pixel with first region having a portion of the absorbing material and a second region not having any portion of the absorbing material,

forming a reflector arrangement on top of the absorbing material portions of the first region of the pixel, thereby defining a reflective pixel region and a transmissive pixel region;

printing colour filter portions, each portion associated with an individual pixel;

substantially planarizing the upper surface of the printed colour filter portions, thereby defining a colour filter for each pixel having a first thickness in the first region of the pixel and a second, greater thickness in the second region of the pixel.

This method provides a low cost implementation of the colour substrate of the invention.

Defining a pattern of absorbing material portions may comprise forming a first pattern of absorbing material portions at the boundaries between adjacent pixels and a second pattern of absorbing material portions in a central region of each pixel, the second pattern thereby defining the first pixel region having a portion of the absorbing material and the second region not having any portion of the absorbing material.

Forming a reflector arrangement on top of the absorbing material portions may further comprise forming the reflectors over the edge of the absorbing material portions and extending partly into the second pixel region.

Multiple colour filter portions can be printed using a single printing operation.

The method may be used in the manufacture of a transflective display device, which further comprises manufacturing a further substrate carrying a plurality of pixel electrodes and sandwiching a liquid crystal layer between the further substrate and the colour filter substrate.

Examples of the invention will now be described in detail with reference to the accompanying drawings, in which:

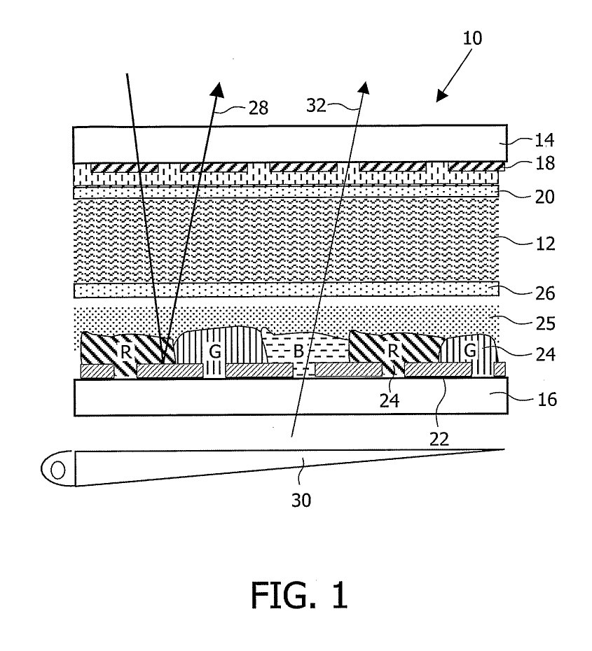

FIG. 1 shows in the cross section a known liquid crystal cell 10, for a transflective liquid crystal display;

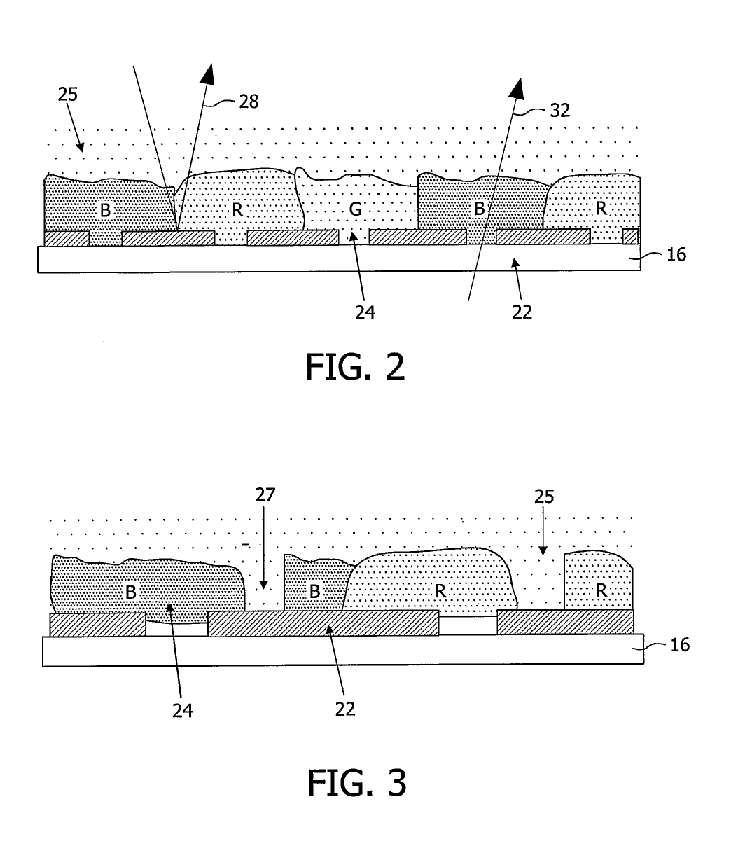

FIG. 2 shows more clearly the second substrate used in the arrangement of FIG. 1, in cross section;

FIG. 3 shows one known approach for matching the colour performance in the two modes of operation;

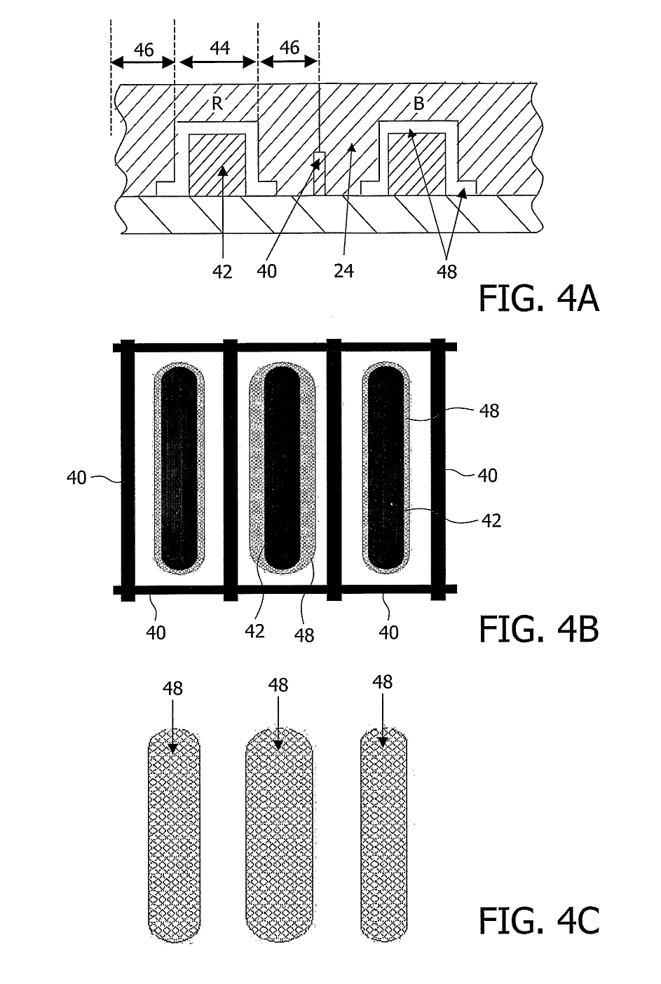

FIGS. 4A to 4C show a first embodiment of colour filter substrate of the invention;

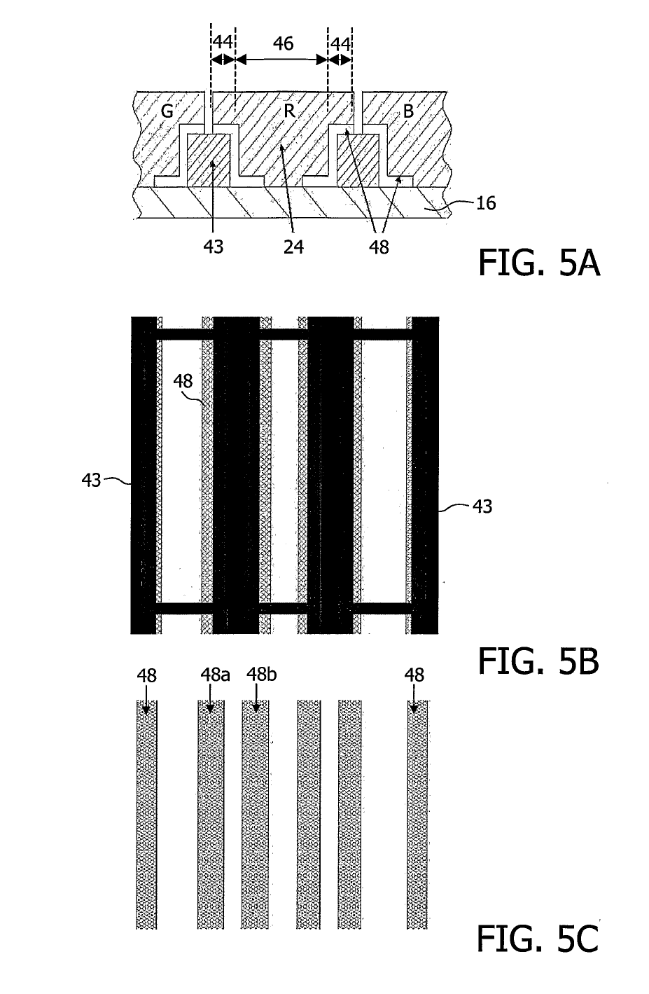

FIGS. 5A to 5C show a second embodiment of colour filter substrate of the invention;

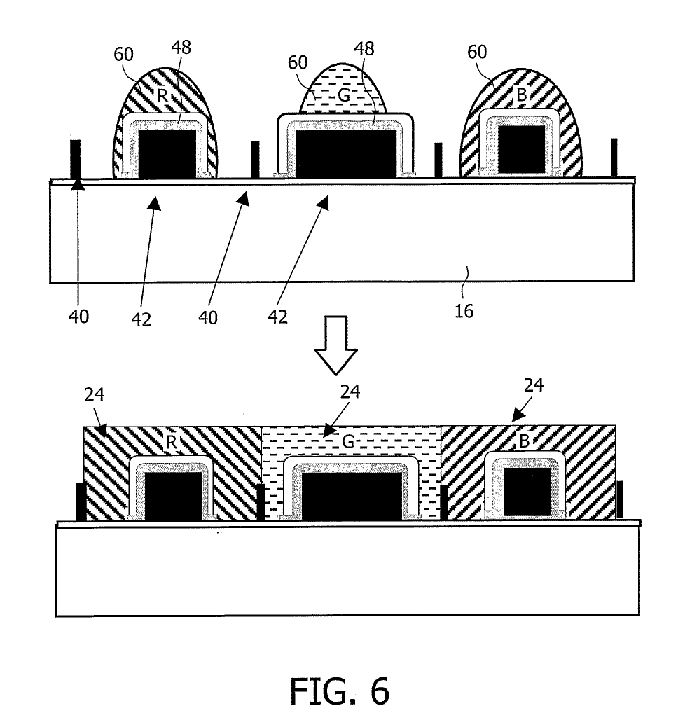

FIG. 6 shows a manufacturing method of the invention for the substrate of FIG. 4;

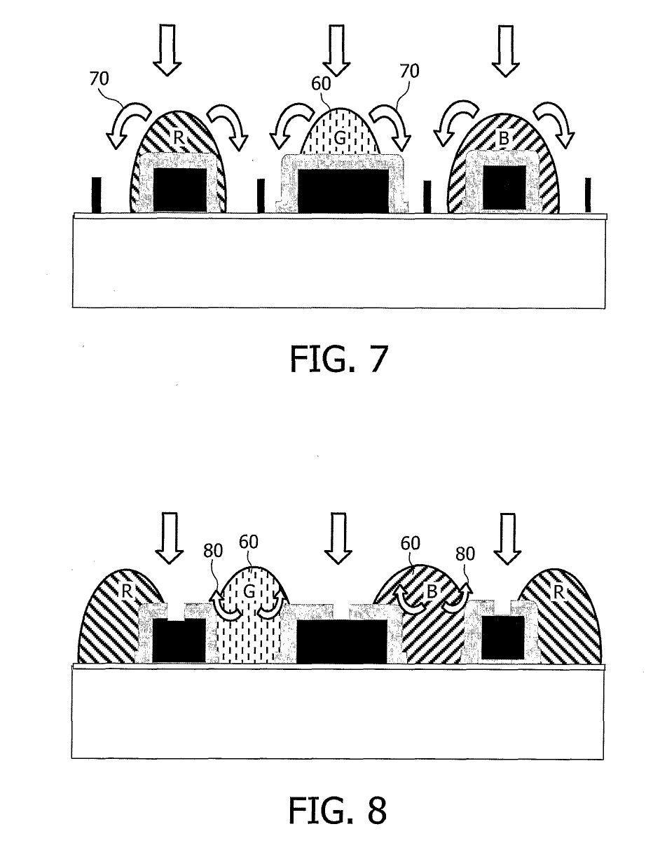

FIG. 7 shows how the pressing operation for the manufacture of the substrate of FIG. 4 causes ink to flow;

FIG. 8 shows how the pressing operation for the manufacture of the substrate of FIG. 5 causes ink to flow;

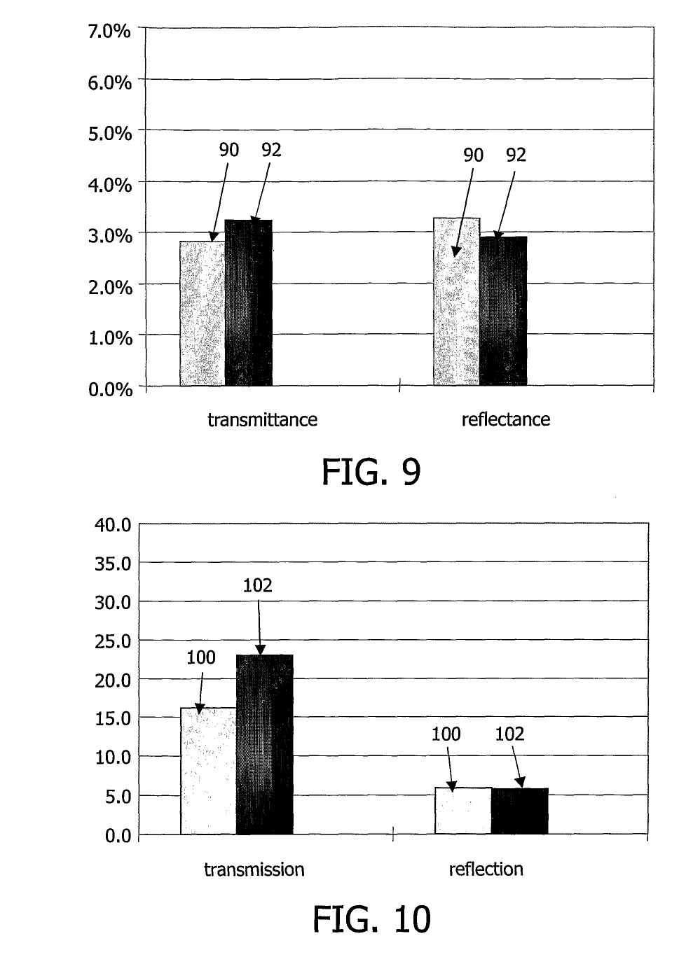

FIG. 9 shows the transmittance and reflectance performance of the substrates of the invention;

FIG. 10 shows the contrast ratio performance in transmissive mode and reflective mode of the substrates of the invention;

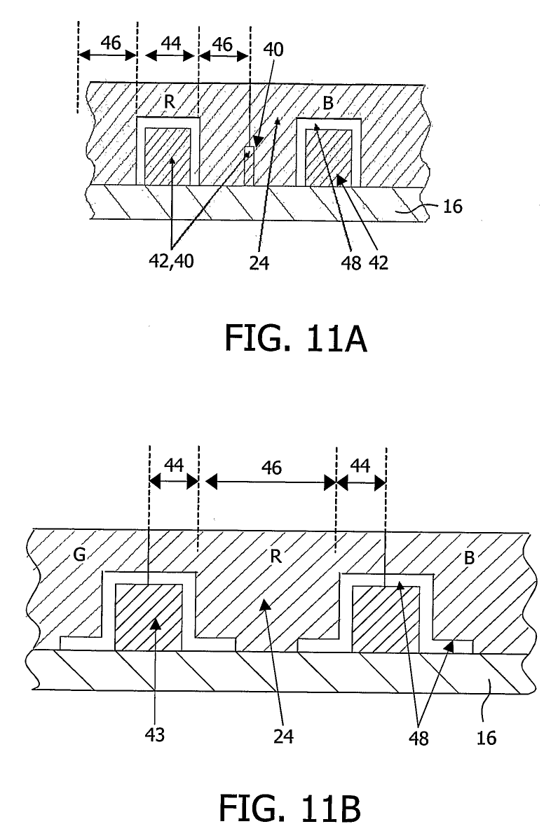

FIGS. 11A and 11B show modifications to FIGS. 4A and 5A; and

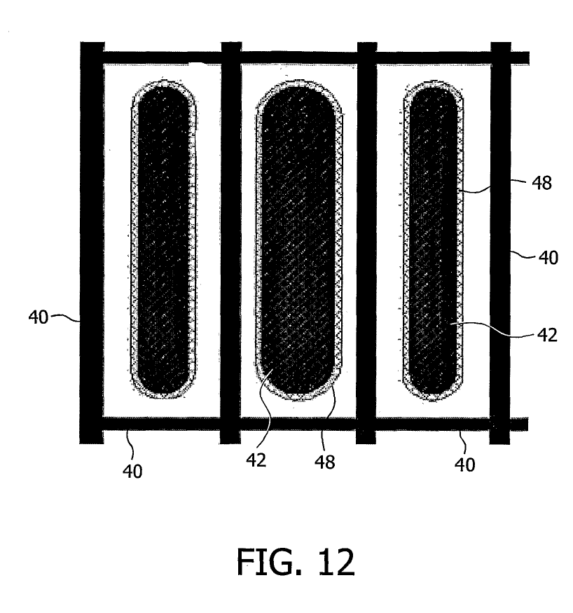

FIG. 12 shows the arrangement of FIG. 11A in plan view.

It should be noted that the figures are schematic and are not drawn to scale. The same reference numbers and characters are used throughout the figures to denote the same, or similar, parts.

The letters R, G and B in the drawings signify the colours red, green and blue respectively.

One implementation of transflective display device of the invention has a colour filter portion for each pixel which includes portions of two different thicknesses for the reflective part of the pixel. The relative thicknesses as well as the area of the reflective part of the pixel associated with each thickness can be controlled to enable independent control of the colour filtering characteristics in the reflective and transmissive modes of operation. Another implementation uses different portions of light absorbing material for the functions of pixel definition and height adjustment, but these may be achieved with a single patterned layer.

FIG. 1 shows in the cross section a known liquid crystal cell 10, for a transflective liquid crystal display.

Liquid crystal material 12 is sandwiched between a first substrate 14 and a second substrate 16, both of which formed from a transparent material, such as glass or plastics. Pixel electrodes 18 are arranged as a matrix on the first substrate 14 and an orientation film 20 is printed in the first substrate 14. The pixel electrodes may be part of a pixel circuit in the case of an active matrix display, or the transflective display may be a passive matrix device.

The second substrate 16 carries a reflector pattern 22, which defines reflective pixel regions, and the gaps in the pattern define transmissive pixel regions. The reflector pattern 22 is formed by Aluminium or an alloy of Aluminium and some other metals.

A color filter arrangement 24 is provided over the pattern 22, and the counter electrodes 26 are provided over a polymer coating layer 25 on top of the colour filters. The counter electrodes 26 and the electrodes 18 control the state of the LC material between the electrodes.

The display reflects light incident from the first substrate side (arrow 28), and transmits light through the openings of the reflector layer from the backlight 30 (arrow 32).

FIG. 2 shows more clearly the second substrate used in the arrangement of FIG. 1, in cross section. The reflective film 22 is provided over the substrate with openings defining the transmissive part of each pixel. The color filter 24 is formed on the reflective film 22, and the reflective film is also associated with a black mask matrix for providing light blocking at the junctions between the colour filter portions.

The reflected light 28 passes through the same color layer as the transmitted light 32. As a result, the performance of the display in the reflective mode cannot be balanced with the performance in the transmissive mode, in respect of brightness and NTSC Ratio. The colour filters are typically produced with multiple photolithographic processes, giving a complicated manufacturing process.

One known approach for improving the matching of the colour performance in the two modes of operation is to mix white light in the reflecting mode with light which has been colour filtered. An example of colour filter substrate for achieving this is shown in FIG. 3. The colour filter 24 for each pixel is removed (at 27) from a part of the reflective part of the pixel, so that part of the light output in the reflecting mode is unfiltered ambient (white) light, which changes the colour point.

It is also known to arrange the thickness of the colour filter layer to be different for the different parts of the pixel, and this invention relates specifically to this approach.

In particular, this invention aims to provide an inexpensive color filter substrate and to provide, with a simple structure, good balance in brightness and NTSC ratio for both the reflective and transmissive modes of operation of the transflective display. The invention also aims to provide a method for manufacturing the color filter substrate.

FIGS. 4A to 4C show a first embodiment of colour filter substrate of the invention. FIG. 4A shows the substrate in cross section, FIG. 4B shows the substrate in plan view, and FIG. 4C shows the pattern of the reflector.

The colour filter substrate comprises a first pattern 40 of absorbing material portions at the boundaries between adjacent pixels and a second pattern 42 of absorbing material portions in a central region of each pixel. These two patterns 40,42 are defined by the same layer, in the form of a resin-based black mask layer, which is deposited and patterned using a photolithographic process.

The second pattern 42 defines a first pixel region 44 having a portion of the absorbing material and a second region 46 not having any portion of the absorbing material layer. The reflector arrangement 48 is provided on top of the absorbing material portions of the second pattern 42, and also extending over the side walls of the portions 42 and into the second region 46 in the example shown.

Each pixel is provided with a colour filter 24 having a first thickness in the first region 44 of the pixel and a second, greater thickness in the second region 46 of the pixel, as shown.

With this arrangement, the optical path lengths that reflected light and transmitted light experience in the color layer will be different, so that good balance in both brightness and NTSC ratio can be achieved by adjusting the thickness of color layer on the reflector film and the type of the color film. The performance can be maintained for the transmissive mode of operation

FIG. 4B shows the substrate in plan view, and shows the separate black mask patterns 40 and 42 and the reflector patterns 48. As shown (only in FIG. 4B and not in FIG. 4A), the reflector patterns may have different sizes for the different colours. In particular, the reflector for a pixel extends over the edge of the black mask portion 42 so that the reflector includes a portion at substrate level. This in turn means that part of the colour filter for the reflective mode has the lesser thickness and part of the colour filter layer has the greater thickness. The ratio of the pixel areas associated with each thickness provides a further parameter which can be controlled to obtain the best balance between the performance in the reflective and the transmissive modes of operation.

FIG. 4C shows the reflector pattern 48 for the three different colour sub-pixels, and shows the different sizes.

FIGS. 5A to 5C show a second embodiment of colour filter substrate of the invention. FIG. 5A shows the substrate in cross section, FIG. 5B shows the substrate in plan view, and FIG. 5C shows the pattern of the reflector. The use of a reflector at both heights over the substrate is shown more clearly for this embodiment.

The colour filter substrate again comprises a pattern 43 of absorbing material portions at the boundaries between adjacent pixels. In this example, a single pattern is defined with each portion of material performing the two functions of providing pixel delineation and different heights for the colour filter. The pattern 43 again defines a first pixel region 44 having a portion of the absorbing material and a second region 46 not having any portion of the absorbing material portions.

The reflector arrangement 48 is provided on top of the absorbing material portions of the first region 44 of the pixel, and is again also shown as extending over the edge of the absorbing material portions and extending partly into the second pixel region 46. Each pixel is again provided with a colour filter having a first thickness in the first region 44 of the pixel and a second, greater thickness in the second region 46 of the pixel, as shown.

FIG. 5B shows the substrate in plan view, and shows the black mask pattern 43 having wider column direction sections than the row direction sections of the black mask pattern. The reflector patterns 48 are provided only over column parts of the pattern 43, and as shown in FIG. 5C, this enables the reflector pattern 48 to be defined simply as an array of parallel lines. The reflector portions 48 may again have different sizes for the different colours.

The reflector portions 48 are arranged as a pair of parallel lines 48a,48b for each column of the black mask pattern 43, and the gap between these lines provides the pixel delineation in the reflective mode. In the transmissive mode, the full black mask pattern 43 provides the pixel separation. This gap is, however, not essential.

The invention thus provides a low cost color filter substrate with simple structure and with excellent performance.

The invention also provides a low cost manufacturing method, which will first be explained generally with reference to FIG. 6, which relates to the manufacture of the colour filter substrate of FIG. 4.

After formation of the absorbing material portions 40,42 and the reflectors 48 (shown as a two-layer structure in FIG. 6), colour filter portions 60 are printed on top of the reflector portions as shown in the top figure. The printing operation comprises a synchronous printing method.

In this method, a red ink pattern, a green ink pattern and a blue ink pattern are deposited in sequence onto a common printing plate. The multiple colour ink pattern on the common printing plate is then transferred to a transfer roller, which is then rolled over the substrate to transfer all three colour patterns in one printing step. The printed pattern is then spread using a spreading roller.

This printing process defines the array of filter portions of three different colours in a single printing step, which gives a simple and low cost process flow. After the pressing step, as shown in the bottom figure, the filters 24 are defined. The volumes of printing ink used ensure that the boundaries between colour filters align with the black mask portions 40. FIG. 6 also shows schematically that the black mask portion for the different colour sub-pixels may also not be the same size.

FIG. 7 shows how the pressing operation for the manufacture of the substrate of FIG. 4 causes ink to flow from above the reflector pattern towards the pixel boundaries (arrows 70).

For the embodiment of FIG. 5, the colour filter portions 60 are again deposited in the central part of the pixel, but this is the deeper part of the pixel. This means that less filter material needs to flow (arrows 80) and this can give more accurate alignment of the pixel filters with the desired pixel boundaries.

The transmittance of the arrangement of FIG. 5 is likely to be better than for the arrangement of FIG. 4, as a result of alignment issues between the colour filter pattern and the pixel electrode pattern, although the FIG. 5 version may exhibit improved contrast particularly in transmission. The reflectance of the FIG. 5 arrangement is likely to be slightly lower, again as a result of alignment issues between the colour filter pattern and the pixel electrode pattern. These effects are due to the fact that there is color layer mixing in the transmission area of the FIG. 4 version but in the reflection area of the FIG. 5 version, as can be seen from FIGS. 7 and 8.

These differences in performance are summarised by FIGS. 9 and 10.

FIG. 9 shows the transmittance (left plots) and reflectance (right plots) for a sample manufactured using the design of the FIG. 4 embodiment (plot 90) and the FIG. 5 embodiment (plot 92)

FIG. 10 shows the contrast ratio in transmissive mode (left plots) and reflective mode (right plots) for a sample manufactured using the design of the FIG. 4 embodiment (plot 100) and the FIG. 5 embodiment (plot 102).

The samples for these results have a thickness ratio between the thin and thick colour filter regions of 1:2, and improved performance can be achieved by increasing this ratio to 1:3 or 1:4.

The overall performance in both transmission and reflection, and the manufacturing process, means that the embodiment of FIG. 5 is preferred. In order to improve the reflection performance of this embodiment, it is possible to alter the ratio of the thin colour filter thickness to the thick colour filter thickness. This ratio may typically lie between 1:2 and 1:4. The thinner the filter layer associated with the reflective part of the pixel, the greater the reflectance, although at the expense of lower colour saturation of reflection.

As mentioned above, the reflector in the example of FIG. 4A extends over the edges of the black mask layer and into the area of the pixel with the grater thickness. This is not essential, and FIG. 11A shows an example in which the reflector is on top of the upper surface of the black mask layer and down the side walls, but there is no part of the reflective region of the pixel having the greater thickness colour filter. As also mentioned above, the gap between portions of the reflector in FIG. 5A is also not essential, and an example with no gap is shown for completeness in FIG. 11B.

FIG. 12 shows the substrate of FIG. 11A in plan view. The reflector patterns 48 in FIG. 4B and FIG. 12 are exactly the same and the transmissive performance is accordingly the same. The black mask layer regions for different sub pixels are the same in FIG. 4B, and accordingly the different color volumes required by the printing process are exactly the same. The black mask regions for different sub-pixels in FIG. 12 are different, and accordingly the color volumes required by the printing process are different. Therefore, the reflective performances of the examples of FIGS. 4B and

FIG. 12 are different. It will be seen that the invention provides a number of different parameters which can be used to control the transmissive and reflective performance and to provide different designs for the different colour sub-pixels.

As mentioned above, an active matrix implementation is possible and tin this case the pixels will each also include a thin film transistor. This may have a top gate structure or a bottom gate structure.

The processes and materials used for the pixel substrate and the LC layer have not been described in detail, as these are conventional. Similarly, the printable materials used for the colour filters are well known to those skilled in the art.

The invention has been described in detail in connection with a liquid crystal display, but other light modulating display types may also benefit from the invention

Various modifications will be apparent to those skilled in the art.

1. A transflective display device, comprising:
a first substrate (14) carrying a plurality of pixel electrodes (18);
a second substrate (16) comprising a plurality of counter-electrodes (26), an array of colour filter devices (24) and a reflector arrangement (48), the reflector arrangement defining a reflective pixel region and a transmissive pixel region; and
a layer of display material (12) sandwiched between the first and second substrates,
wherein the second substrate (16) comprises a pattern of absorbing material portions (40,42;43) provided at least at the boundaries between adjacent pixels and each pixel comprising a first region (44) having a portion of the absorbing material and a second region (46) not having any portion of the absorbing material (40,42;43), the reflector arrangement (48) being provided on top of the absorbing material portions (42;43) of the first region of the pixel, over the edge of the absorbing material portions and extending partly into the second pixel region (46), and wherein each pixel is provided with a colour filter (24) having a first thickness in the first region of the pixel and a second, greater thickness in the second region of the pixel.

2. The device as claimed in claim 1, wherein the absorbing material portions (43) are provided at the boundaries between adjacent pixels, such that the central part of each pixel is the second region (46).

3. A device as claimed in claim 2, wherein the reflector arrangement includes openings at the boundaries between pixels.

4. A transflective display device, comprising:
a first substrate (14) carrying a plurality of pixel electrodes (18);
a second substrate (14) comprising a plurality of counter-electrodes (26), an array of colour filter devices (24) and a reflector arrangement (48), the reflector arrangement (48) defining a reflective pixel region and a transmissive pixel region; and
a layer of display material (12) sandwiched between the first and second substrates,
wherein the second substrate (16) comprises a first pattern (40) of absorbing material portions at the boundaries between adjacent pixels and a second pattern (42) of absorbing material portions in a central region of each pixel, the second pattern defining a first pixel region (44) having a portion of the absorbing material and a second region (46) not having any portion of the absorbing material, the reflector arrangement (48) being provided on top of the absorbing material portions (42) of the second pattern, and wherein each pixel is provided with a colour filter (24) having a first thickness in the first region of the pixel and a second, greater thickness in the second region of the pixel.

5. The device as claimed in claim 4, wherein the reflector arrangement (48) is provided over the edge of the absorbing material portions of the second pattern and extends partly into the second pixel regions (46).

6. The device as claimed in any preceding claim, wherein the reflective arrangement (48) comprises a patterned smooth aluminium layer.

7. The device as claimed in any preceding claim, further comprising a backlight (30) provided adjacent the second substrate.

8. The device as claimed in any preceding claim, wherein the array of colour filter devices (24) comprise portions of three colours.

9. The device as claimed in any preceding claim, wherein the colour filter devices (24) are formed from printed material.

10. The device as claimed in claim 9, wherein the colour filter devices (24) are formed from a single printed layer.

11. The device as claimed in any preceding claim, comprising an active matrix display device, in which the first substrate (14) carries a plurality of pixel circuits, each including a pixel electrode.

12. The device as claimed in any preceding claim, wherein the display material layer (12) comprises liquid crystal material.

13. A method of manufacturing a colour filter substrate (16) for a transflective display device in which a first substrate (14) carries a plurality of pixel electrodes (18) and a display material layer (12). is provided between the first substrate (14) and the colour filter substrate (16), the method comprising:
defining a pattern of absorbing material portions (40,42;43) over a transparent substrate, the portions being provided at least at the boundaries between adjacent pixels thereby providing each pixel with first region (44) having a portion of the absorbing material and a second region (46) not having any portion of the absorbing material,
forming a reflector arrangement (48) on top of the absorbing material portions (42;43) of the first region (44) of the pixel, thereby defining a reflective pixel region and a transmissive pixel region;
printing colour filter portions (24), each portion associated with an individual pixel;
substantially planarizing the upper surface of the printed colour filter portions, thereby defining a colour filter for each pixel having a first thickness in the first region of the pixel and a second, greater thickness in the second region of the pixel.

14. A method as claimed in claim 13, further comprising forming a plurality of counter-electrodes (26) over the colour filters (24).

15. A method as claimed in claim 14, wherein an overcoat (25) is provided between the colour filter portions (24) and the counter electrodes (26).

16. A method as claimed in any one of claims 13 to 15, wherein forming a reflector arrangement (28) on top of the absorbing material portions further comprises providing openings at the boundaries between pixels.

17. A method as claimed in any one of claims 13 to 15, wherein defining a pattern of absorbing material portions comprises forming a first pattern (40) of absorbing material portions at the boundaries between adjacent pixels and a second pattern (42) of absorbing material portions in a central region of each pixel, the second pattern (42) thereby defining the first pixel region having a portion of the absorbing material and the second region not having any portion of the absorbing material.

18. A method as claimed in any one of claims 13 to 17, wherein forming a reflector arrangement (48) on top of the absorbing material portions further comprises forming the reflectors over the edge of the absorbing material portions (42;43) and extending partly into the second pixel region

19. A method as claimed in any one of claims 13 to 18, wherein colour filter portions (24) are printed using a single printing operation.

20. A method of manufacturing a transflective display device, comprising:
manufacturing a colour filter substrate (16) using a method as claimed in any one of claims 13 to 19;
manufacturing a further substrate (14) carrying a plurality of pixel electrodes (18); and
sandwiching a liquid crystal layer (12) between the further substrate and the colour filter substrate.
